(19) United States
(12) Patent Application Publication
(10) Pub. No.: US 2016/0202129 A1
(43) Pub. Date: Jul. 14, 2016

(54) APPARATUS AND METHOD FOR MEASURING TEMPERATURE OF LED

(71) Applicant: Samsung Display Co., Ltd., Yongin-si (KR)

(72) Inventors: Moon-Hwan CHANG, Yongin-si (KR); Heugon KIM, Yongin-si (KR)

(21) Appl. No.: 14/810,103

(22) Filed: Jul. 27, 2015

(30) Foreign Application Priority Data
Jan. 14, 2015 (KR) 10-2015-0007031

(51) Int. Cl. G01K 13/00; H05B 33/08; G01K 7/01

(52) U.S. Cl. CPC G01K 13/00; G01K 7/01; H05B 33/089

(57) ABSTRACT

Provided is an apparatus for measuring a temperature of an LED, the apparatus including: a chamber in which an LED module is disposed therein, and set to have a plurality of temperatures; a temperature measurement unit measuring a temperature of the LED module and a temperature of the chamber at each of the temperatures; a controller outputting a plurality of current control signals when the temperature of the LED module and the temperature of the chamber are equal to each other; a current supply unit applying a plurality of current pulses having a plurality of current values to the LED module responding to the current control signals; and a voltage detection unit detecting a voltage of the LED module whenever the LED module is driven by each of the current pulses, wherein the controller tabulates the temperatures of the LED module, the current values, and a plurality of pieces of information on the detected voltages by using a lookup table to store the tabulated results.

### CLAIM OF PRIORITY

This U.S. non-provisional patent application claims the priority to and all the benefits accruing under 35 U.S.C. §119 of Korean Patent Application No. 10-2015-0007031, filed on Jan. 14, 2015 in the Korean Intellectual Property Office (KIPO), the entire contents of which are hereby incorporated by reference.

### BACKGROUND OF INVENTION

1. Field of Disclosure

The present disclosure herein relates to an apparatus and a method for measuring a temperature of a light emitting diode LED.

2. Description of the Related Art

Since a light-emitting diode has advantages in energy saving and environmental performance compared to a typical light source, the light-emitting diode is finding its place as a next lighting device. When the light-emitting diode is driven, heat is generated in the light-emitting diode. The heat of the light-emitting diode is proportional to a temperature of the light-emitting diode, and is a factor determining the life span of the light-emitting diode. Therefore, when the temperature of the light-emitting diode is known, the life span of the light-emitting diode may be estimated.

Also, when the temperature of the light-emitting diode excessively rises, the light-emitting diode may be damaged. When the temperature of the light-emitting diode is known, before the light-emitting diode is damaged, the light-emitting diode may be protected by cutting off electric power supplied to the light-emitting diode.

However, the temperature of the light-emitting diode is substantially a temperature of an LED junction that is a P-N junction. In order to measure the temperature of the LED junction, since it is necessary to completely disassemble an LED module, it is substantially difficult to measure the temperature of the LED junction. Therefore, there is a need for a method of measuring the temperature of the junction without disassembling the LED module.

### SUMMARY OF INVENTION

The present disclosure provides an apparatus and a method for measuring a temperature of an LED, in which temperatures of a chamber and driving current values for driving an LED are set to various values so that a temperature of the LED may be measured.

Embodiments of the inventive concept provide apparatuses for measuring a temperature of an LED, the apparatuses including a chamber in which an LED module is disposed therein, and set to have a plurality of temperatures; a temperature measurement unit measuring a temperature of the LED module and a temperature of the chamber at each of the temperatures; a controller outputting a plurality of current control signals when the temperature of the LED module and the temperature of the chamber are equal to each other; a current supply unit applying a plurality of current pulses having a plurality of current values to the LED module responding to the current control signals; and a voltage detection unit detecting a voltage of the LED module whenever the LED module is driven by each of the current pulses, wherein the controller tabulates the temperatures of the LED module, the current values, and a plurality of pieces of information on the detected voltages by using a lookup table to store the tabulated results.

In some embodiments, the temperatures may be gradually raised by a predetermined level.

In other embodiments, the current values of the current pulses may be gradually raised by a predetermined level, and the current pulses may be sequentially outputted from the current pulse having a low current value.

In still other embodiments, the current pulses may be applied to the LED module at a distance of predetermined time.

In even other embodiments, each of the current pulses may have a pulse width of about 910 μs.

In yet other embodiments, the controller may store the temperature of the LED module when the temperature of the LED module and the temperature of the chamber are equal to each other.

In still further embodiments, the plurality of pieces of information on the current values may be preset and be stored in the controller, and the controller may generate current control signals corresponding to the plurality of pieces of information on the current values when the temperatures of the LED module and the temperature of the chamber are equal to each other.

In further embodiments, the chamber may be set to have various temperatures by control of the controller.

In even further embodiments, the current supply unit may be a constant current supply unit.

In yet further embodiments, the detected voltage may be a forward voltage of an LED of the LED module.

In much further embodiments, the controller may include a memory tabulating the temperatures of the LED module, the current values, and a plurality of pieces of information on the detected voltages by using a lookup table to store the tabulated results.

In other embodiments of the inventive concept, methods for measuring a temperature of an LED, the methods including setting, to predetermined temperature, a chamber in which an LED module is disposed therein; measuring a temperature of the LED module and a temperature of the chamber; generating a plurality of current pulses having a plurality of current values to apply the generated current pulses to the LED module when the temperature of the LED module and the temperature of the chamber are equal to each other; detecting a voltage of the LED module whenever the LED module is driven by each of the current pulses; tabulating the temperature of the LED module, the current values, and a plurality of pieces of information on the detected voltages by using a lookup table to store the tabulated results; raising a temperature value set to the temperature of the chamber by a predetermined level; comparing the temperature value and a maximum temperature; and setting the temperature of the chamber to the temperature value when the temperature value is equal to or lower than the maximum temperature.

In some embodiments, the current values of the current pulses may be gradually raised, and the current pulses may be sequentially outputted from the current pulse having a low current value.

In other embodiments, the current pulses may be applied to the LED module at a distance of predetermined time.

In still other embodiments, each of the current pulses may have a pulse width of about 910 μs.

In even other embodiments, the methods may further include storing the temperature of the LED module when the temperatures the LED module and the chamber are equal to each other.

In yet other embodiments, the generating of the current pulses may include: presetting and storing the plurality of pieces of information on the current values; generating current control signals corresponding to the plurality of pieces of information on the current values when the temperatures the LED module and the chamber are equal to each other; and responding to the current control signals to generate the current pulses, and applying the generated current pulses to the LED module.

In further embodiments, the current pulses may be generated from a constant current supply unit.

In still further embodiments, the detected voltage may be a forward voltage of an LED of the LED module.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram showing an apparatus for measuring a temperature of an LED according to an embodiment of the inventive concept;

FIG. 2 is a graph showing temperature of LED according to time when current having a maximum current value of current values of current pulses is applied to the LED for predetermined time;

FIG. 3 is a graph showing voltages measured in an LED when current values of current pulses are applied to an LED module at a temperature of a chamber;

FIG. 4 is a graph showing a relationship of a current applied to an LED versus a voltage measured in the LED; and

FIG. 5 is a flow chart showing a method for measuring a temperature of an LED according to an embodiment of the inventive concept.

### DETAILED DESCRIPTION

Advantages and features of the invention concept, and implementation methods thereof will be clarified through following embodiments described with reference to the accompanying drawings. The invention concept may, however, be embodied in different forms and should not be construed as limited to the embodiments set forth herein. Rather, these embodiments are provided so that this disclosure will be thorough and complete, and will fully convey the scope of the inventive concept to those skilled in the art. Further, the inventive concept is only defined by scopes of claims. In the drawings, like reference numerals refer to like elements throughout.

It will be understood that when element or layer (or film) is referred to as being “on/over” another element or layer, it can be directly on another element or layer, or intervening elements or layers may also be present. In contrast, when an element is referred to as being “directly on” or “directly over” another element, there are no intervening elements present. The term “and/or” includes any and all combinations of one or more of the associated listed items.

Spatially relative terms, “below”, “beneath”, “lower”, “above”, “upper” and the like may be used to indicate the relationship between one device or constituent elements and other devices or constituent elements, as shown in the drawings. It should be understood that the spatially relative terms include the direction illustrated in the drawings as well as other directions of devices during use or operation. In the drawings, like reference numerals refer to like elements throughout.

Though terms like a first and a second are used to describe various elements, components, and/or sections in various embodiments, the elements, components, and/or sections should not be limited by these terms. These terms are only used to distinguish one element, component, or section from another. Therefore, a first element, a first component or a first section discussed below could be termed a second element, a second component or a second section without departing from the teachings of the inventive concept.

Additionally, the embodiment in the detailed description will be described with schematic sectional views and/or plain views as ideal exemplary views of the invention concept. Accordingly, shapes of the exemplary views may be modified according to manufacturing techniques and/or allowable errors Therefore, the embodiments of the inventive concept are not limited to the specific shape illustrated in the exemplary views, but may include other shapes that may be created according to manufacturing processes. Areas exemplified in the drawings have general properties, and are used to illustrate a specific shape of a semiconductor package region. Thus, this should not be construed as limited to the scope of the inventive concept.

Hereinafter, exemplary embodiments of the inventive concept will be described in more detail with reference to accompanying drawings.

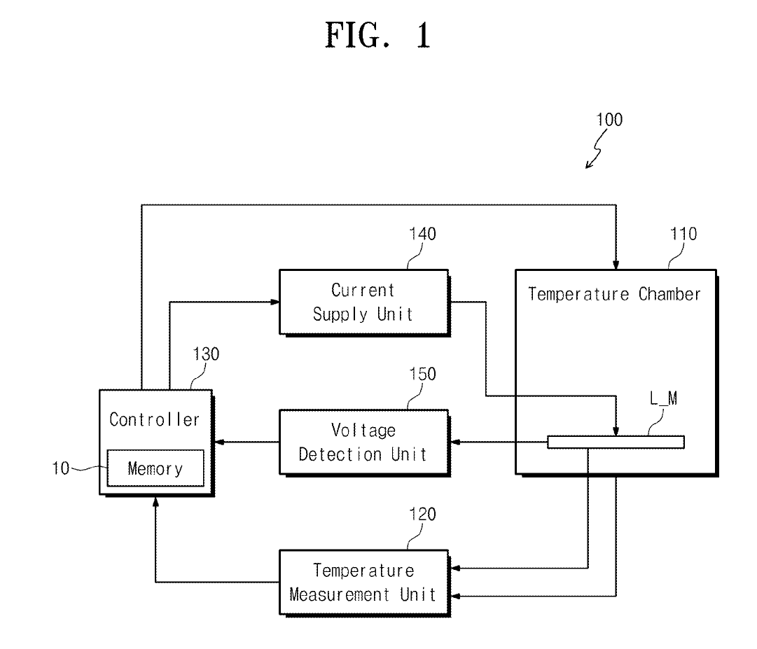

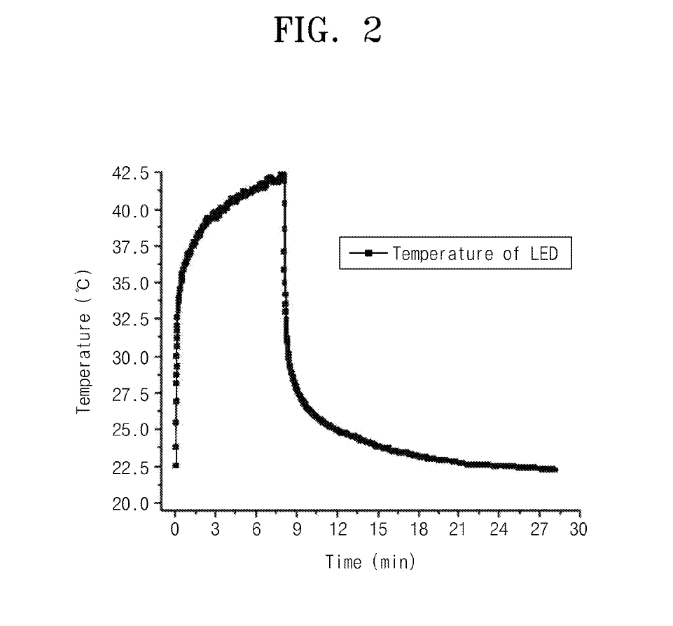

FIG. 1 is a block diagram showing an apparatus for measuring a temperature of an LED according to an embodiment of the inventive concept. FIG. 2 is a graph showing temperature versus time of an LED when current having a maximum current value of current values of current pulses is applied to the LED for predetermined time.

Referring to FIG. 1, an apparatus 100 for measuring a temperature of an LED includes a chamber 110, a temperature measurement unit 120, a controller 130, a current supply unit 140, a voltage detection unit 150, and a light-emitting diode module L-M (hereinafter, referred to as an LED module).

Although not shown, the LED module L-M includes a light-emitting diode (LED), a substrate mounted with an LED, and LED leads respectively connected to anode and cathode electrodes of the LED. The LED module L-M is disposed inside the chamber 110.

The chamber 110 is set to have a plurality of temperatures by control of the controller 130. The temperature of the chamber 110 is gradually increased by a predetermined level. The temperature of chamber 110 may be set to temperatures increased by 15° C., for example, to about 20° C., about 35° C., about 50° C., about 65° C., about 80° C., about 95° C., about 110° C., and about 125° C., by the control of the controller 130.

The temperature measurement unit 120 measures a temperature of the LED module L-M and a temperature of the chamber 110 at each of the temperatures set in the chamber 110. Temperature information of the LED module L-M and temperature information of the chamber 110 measured by the temperature measurement unit 120 are provided to the controller 130.

The controller 130 compares the temperature information of the LED module L-M and the temperature information of the chamber 110 received from the temperature measurement unit 120. When the temperature of the LED module L-M and the temperature of the chamber 110 are equal to each other, the controller 130 stores the temperature information of the LED module L-M, and controls the current supply unit 140 so as to output a plurality of current pulses having a plurality of current values.

The current supply unit 140 may be a constant current supply unit. Whenever the temperature of the LED module L-M and the temperature of the chamber 110 are equal to each other, the current supply unit 140 supplies, to the LED module L-M, current pulses in which a current value is gradually increased by the control of the controller 130.

The voltage detection unit 150 detects forward voltages (hereinafter, referred to as voltages) of the LED module L-M driven by the current pulses. The voltage detection unit 150 supplies the detected voltages to the controller 130.

The controller 130 tabulates the temperatures of the LED module L-M, the current values of the current pulses, and a plurality of pieces of information on the detected voltages by using a lookup table (LUT) to store the tabulated results. For example, the controller 130 includes a memory 10 for tabulating the temperatures of the LED module L-M, current values of the current pulses, and the plurality of pieces of information on the detected voltages by using a lookup table to store the tabulated results.

Hereinafter, more detailed operations of the apparatus 100 for measuring the temperature of the LED will be described with reference to the configurations described above.

The chamber 110 is set to have a predetermined temperature by control of the controller 130. For example, the chamber 110 may be set to have about 20° C. by the control of the controller 130.

After the predetermined time has elapsed, the chamber 110 and the LED module L-M may reach a thermal equilibrium state. The temperatures of the chamber 110 and the LED module L-M that reach a thermal equilibrium state are equal to each other.

That is, after the predetermined time has elapsed, the temperature of the chamber 110 and the temperature of the LED module L-M may be equal to each other. Therefore, the temperature of the LED module L-M may be about 20° C. equal to that of the chamber 110.

When the temperature of the LED module L-M is equal to that of the chamber 110, the temperature of the LED module L-M may be substantially a temperature of an LED junction. Hereinafter, the temperature of the LED junction is referred to as the temperature of an LED.

The temperature of the LED module L-M and the temperature of the chamber 110, which become equal to each other due to the thermal equilibrium state between LED module L-M and the chamber 110, are measured by the temperature measurement unit 120 to be provided to the controller 130 as temperature information.

The controller 130 stores the temperature information of the LED module L-M received from the temperature measurement unit 120. Also, since the temperature of the chamber 110 and the temperature of the LED module (L-M) are equal to each other, the controller 130 controls the current supply unit 140 so as to output current pulses.

The current supply unit 140 sequentially outputs current pulses in which a current value is gradually increased by the control of the controller 130.

That is, when the temperature of the LED module L-M is about 20° C. equal to that of the chamber 110, the current supply unit 140 may output current pulses. For example, the current supply unit 140 generates and outputs current pulses in which the current value is gradually increased by a predetermined level from about 0 mA to about 700 mA. For example, current pulses having current values of about 100 mA, about 200 mA, about 300 mA, about 400 mA, about 500 mA, about 600 mA, and about 700 mA may be sequentially outputted and supplied to the LED module L-M.

A plurality of pieces of information on current values for generating current pulses may be preset and stored in the controller 130. The plurality of pieces of information on the current values correspond to current values of current pulses. The controller 130 generates a plurality of current control signals corresponding to the plurality of pieces of information on current values and supplies the generated current control signals to the current supply unit 140.

The current supply unit 140 responds to the current control signals to generate current pulses and sequentially outputs the generated current pulses from the current pulse having a low current value. Each of the current pulses may have a pulse width of about 910 μs. The current pulses may be supplied to the LED module L-M at a distance of predetermined time.

The LED module L-M is driven by the current pulses received from the current supply unit 140. That is, the current pulses are driving currents for driving an LED of the LED module L-M.

The voltage detection unit 150 detects node voltage whenever the LED module L-M is driven by each current pulse, and provides information on the detected voltage to the controller 130. The voltage is an operation voltage of the LED of the LED module L-M.

The controller 130 stores a plurality of pieces of information on voltages of LED module L-M driven by current pulses. The temperature of the LED module L-M set to about 20° C., current values driving the LED module L-M at a temperature of about 20° C., and voltages of the LED module L-M corresponding to the current pulses at a temperature of about 20° C. may be tabulated by using a lookup table and be stored in the memory 10 of the controller 130.

After that, the controller 130 raise the temperature of the chamber 110 from about 20° C. to about 30° C. When the temperature of the LED module L-M is raised to about 35° C., and the temperature of the LED module L-M is equal to that of the chamber 110, an operation of the aforementioned LED temperature measuring apparatus 100 is performed.

The operation of the foregoing LED temperature measuring apparatus 100 is performed whenever the temperature of the chamber 110 is raised. That is, the controller 130 gradually raises the temperature of the chamber 110, and the operation of the aforementioned LED temperature measuring apparatus 100 is performed at each of the temperatures.

When the temperature of the chamber 110 is raised to maximum temperature, the operation of the LED temperature measuring apparatus 100 is performed with respect to the maximum temperature, and the operation of the LED temperature measuring apparatus 100 is ended. In an exemplary embodiment, the maximum temperature may be about 125° C.

As described above, when the chamber 110 and the LED module L-M reach a thermal equilibrium state, the temperature of the LED module L-M may be a temperature of an LED. Therefore, temperature information of the LED corresponding to a temperature of the LED module L-M, a plurality of pieces of information on current values driving the LED at a temperature of the LED, and a plurality of pieces of information on voltages of the LED may be tabulated by using a lookup table and be stored in the memory 10 of the controller 130.

When the temperature of the LED module L-M is equal to that of the chamber 110, the operation voltage of the LED module L-M is measured according to a driving current of the LED module L-M. Since the temperature of the LED module L-M is the temperature of the LED, the temperature of the LED, which corresponds to specific driving current and specific operation voltage, may be derived by the operation of the aforementioned LED temperature measuring apparatus 100. That is, the temperature of the LED may be indirectly measured.

As a result, in the LED temperature measuring apparatus 100 according to an embodiment of the inventive concept, the temperatures of the chamber 110 and the current values for driving the LED may be set to have various values to measure the temperature of the LED.

Referring to FIG. 2, a current value applied to the LED is about 700 mA in FIG. 2. That is, a maximum current of current values of the current pulses may be about 700 mA. Also, room temperature is about 22.5° C. That is, an initial temperature of the LED is about 22.5 ° C.

A current of about 700 mA was applied to the LED for about 8 minutes and then was cut off. A temperature of the LED is raised while the current is applied, and after the current is cut off, the temperature of the LED is lowered.

An analysis of test results shown in FIG. 2 shows that the temperature of the LED is rapidly raised to about 32.5° C. when current is applied to the LED for about 0.25 minutes. Substantially, the temperature of the LED is linearly raised from about 22.5° C. to about 32.5° C. . That is, the time that the temperature of the LED is raised from about 22.5° C. to about 32.5° C. is about 0.25 minutes.

Accordingly, when a temperature interval of about 10° C. in which the temperature of the LED is linearly raised is divided by about 0.25 minutes (15 seconds), is calculated in micro scales, and then is multiplied by about 910, it may be calculated how much is the temperature of the LED in an interval of about 910 μs raised. Referring to test results shown in FIG. 2, the temperature of the LED is raised by about 0.00061 ° C. in the interval of about 910 μs ° C.

Generally, when the LED is driven by applying current, the temperature of the LED is raised and is continuously raised in proportion to a current value.

As described above, the current pulse outputted in the current supply unit 140 has a pulse width of about 910 μs and a maximum current of about 700 mA. When the maximum current is applied to the LED module L-M for about 910 μs in the LED temperature measuring apparatus 100, the temperature of the LED module L-M may be raised by about 0.00061° C. When a current pulse having a current value lower than the maximum current is applied to the LED, the temperature of the LED will be raised by a temperature lower than about 0.00061° C.

Therefore, when the temperature of the LED module L-M is measured in the LED temperature measuring apparatus 100, an influence due to a temperature rise of the LED module L-M according to a current pulse may be negligible.

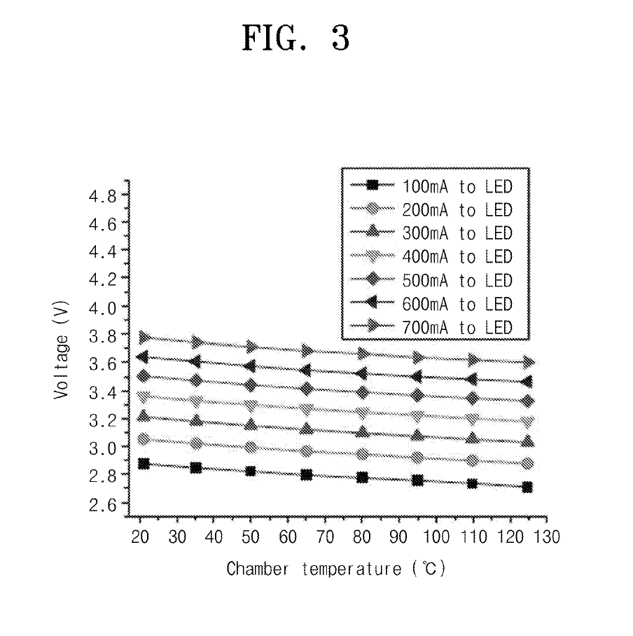

FIG. 3 is a graph showing voltages detected in an LED when current values of current pulses are applied to an LED module at a temperature of a chamber.

Referring to FIG. 3, the temperatures of the chamber 110 shown in FIG. 3 are temperatures at which the chamber 110 is substantially in thermal equilibrium with the LED module L-M. That is, the temperatures of the chamber 110 in FIG. 2 are the temperatures of the LED module L-M.

In an exemplary embodiment, the temperatures of the chamber 110 in FIG. 2 were set to about 20° C., about 35° C., about 50° C., about 65° C., about 80° C., about 95° C., about 110° C., and about 125° C., respectively. The current values of the current pulses were set to about 100 mA, about 200 mA, about 300 mA, about 400 mA, about 500 mA, about 600 mA, and about 700 mA, respectively.

As shown in FIG. 3, the current values of the current pulses were applied to the LED of the LED module L-M at the temperatures of the chamber 110, and voltages of the LED were detected. As described above, the detected voltages of the LED are forward voltages.

Voltages detected according to the current values of the current pulses at the temperatures of the chamber 110 have different values.

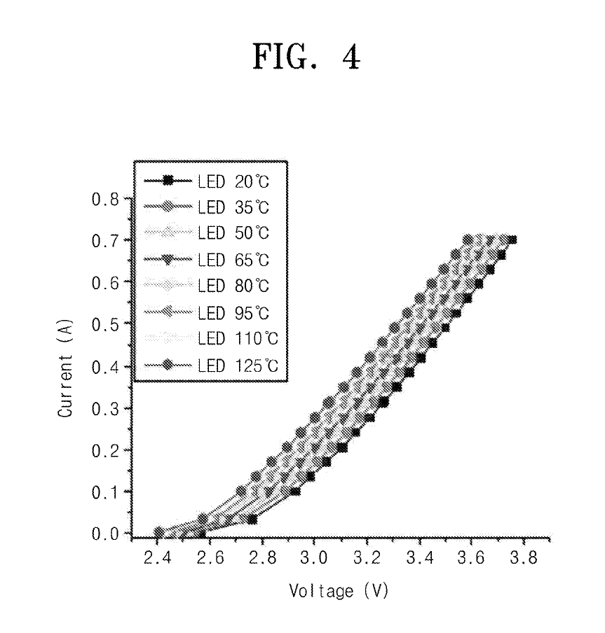

FIG. 4 is a graph showing a relationship of a current value applied to an LED versus a voltage measured in the LED.

Referring to FIG. 4, the current pulses having current values more various than current values shown in FIG. 3 were applied to the LED of the LED module L-M, and voltages of the LED were detected. The temperatures of the LED shown in FIG. 4 are the temperatures of the LED module L-M that is thermal equilibrium with the chamber 110, and substantially indicate the temperatures of the LED.

When current pulses having the same current value were applied to the LED, voltages were differently detected according to the temperatures of the LED. Accordingly, the temperatures of the LED may be estimated by verifying the variations in voltage and current value.

When the LED module L-M is used in different apparatuses, the temperature of the LED may be estimated by using information measured in the LED temperature measuring apparatus 100.

For example, when it is necessary to adjust a luminance of light generated in the LED according to brightness there around, various driving voltages may be applied to the LED. In this case, the temperature of the LED may be estimated by verifying the relation between current values and voltages values.

When the estimated temperature of the LED is a temperature at which the LED is damaged, electric power supplied to the LED module L-M may be cut off to protect the LED.

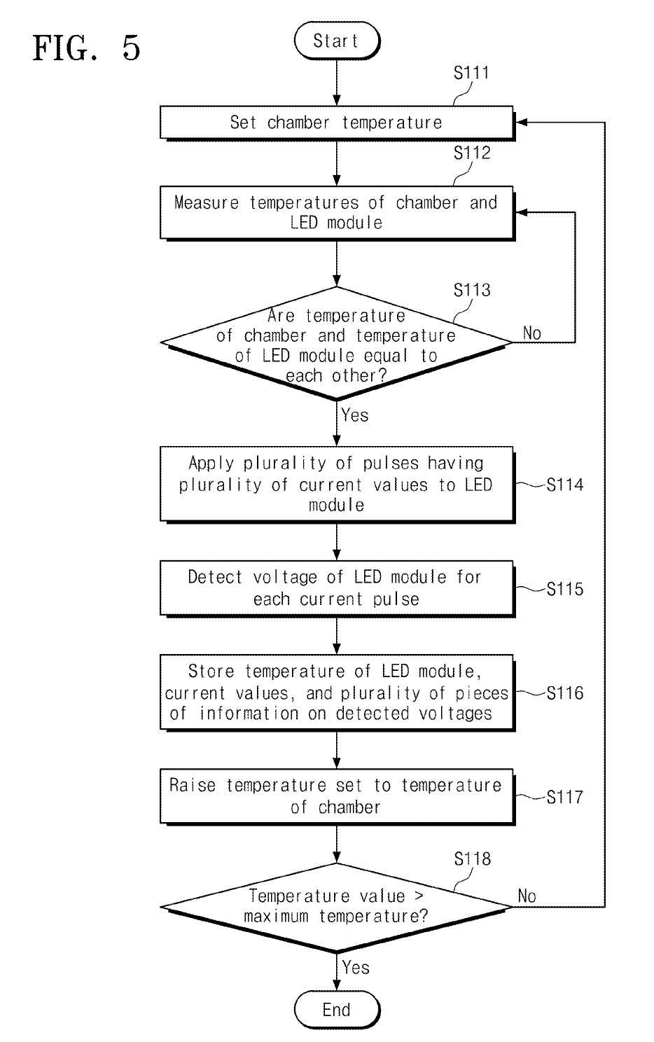

FIG. 5 is a flow chart showing a method for measuring a temperature of an LED according to an embodiment of the inventive concept.

Referring to FIG. 5, the temperature of the chamber 110 is set by control of the controller 130 in step S111.

The temperatures of the chamber 110 and the LED module L-M disposed inside the chamber 110 are measured by the temperature measurement unit 120 in step S112. A plurality of pieces of information on the temperatures of the chamber 110 and the LED module L-M are provided to the controller 130.

The temperatures of the chamber 110 and the LED module L-M are compared in step S113. When the temperatures of the chamber 110 and the LED module L-M are equal to each other, a plurality of current pulses having a plurality of current values are generated in the current supply unit 140 to be applied to the LED module L-M in step S114. As described above, the current values of the current pulses are gradually increased by a predetermined level.

Although not shown, when the temperatures of the chamber 110 and the LED module L-M are equal to each other, the temperature of the LED module L-M is stored in the controller 130 in step S114. Also, a plurality of pieces of information on current values are preset and stored in the controller 130. In addition, when the temperatures of the chamber 110 and the LED module L-M are equal to each other, the controller 130 generates current control signals corresponding to the plurality of pieces of information on current values in step S 114. Therefore, the current supply unit 140 responds to the current control signals to generate current pulses.

A voltage of the LED module is detected for each current pulse by the voltage detection unit 150 in step S 115. The detected voltage is a forward voltage of the LED of the LED module L-M.

For example, the temperatures of the LED module L-M, current values of the current pulses, and a plurality of pieces of information on the detected voltages are tabulated by using a lookup table to be stored in the memory 10 of the controller 130 in step S116.

A temperature value set to the temperature of the chamber 110 is raised by a predetermined level in step S117. For example, as described above, the temperature value may be raised by about 15° C.

It is inspected whether or not the temperature of the chamber 110 is the maximum temperature in step S118. The aforementioned operations are substantially performed in the controller 130. For example, the controller 130 raises the temperature set to the temperature of the chamber 110 by a predetermined level and compares the raised temperature and the maximum temperature. In an exemplary embodiment, the maximum temperature may be about 125° C.

When the raised temperature is greater than the maximum temperature in step S118, a measuring operation of the temperature of the LED is ended. When the raised temperature is equal to or lower than the maximum temperature in step S 118, the operation is returned to step S111 and the temperature of the chamber 110 is set to the raised temperature value, and an operation of next step is performed. The aforementioned operations are substantially performed in the controller 130. That is, the controller 130 gradually raises the temperature of the chamber 110 until the chamber 110 is set to the maximum temperature, and performs a measuring operation of the temperature of the LED.

Therefore, temperature information of the LED corresponding to a temperature of the LED module L-M, a plurality of pieces of information on current values driving the LED at a temperature of the LED, and a plurality of pieces of information on voltages of the LED are tabulated by using a lookup table through the aforementioned operations and are stored in the memory 10 of the controller 130.

Since the temperature of the LED module L-M is the temperature of the LED, the temperature of the LED, which corresponds to specific driving current and specific operation voltage, may be derived by the method for measuring the temperature of the LED.

As a result, in then method for measuring the temperature of the LED according to an embodiment of the inventive concept, the temperature of the chamber 110 and the current values for driving the LED may be set to various values to measure the temperature of the LED.

According to an apparatus and a method for measuring a temperature of an LED, temperatures of a chamber and driving current values for driving an LED are set to various values, so that a temperature of the LED may be measured.

While the present invention has been particularly shown and described with reference to exemplary embodiments thereof, it will be understood by those of ordinary skill in the art that various changes in form and details may be made therein without departing from the spirit and scope of the inventive concept. Further, it should be construed that embodiments disclosed here are examples in all aspects and not restrictive. It is intended that the scope of the present invention is defined by claims, not by the description above, and encompasses all modifications and variations equivalent in meaning and scope to the claims.

What is claimed is:

1. An apparatus for measuring a temperature of an LED, the apparatus comprising:
a chamber in which an LED module is disposed therein, and set to have a plurality of temperatures;
a temperature measurement unit measuring a temperature of the LED module and a temperature of the chamber at each of the temperatures;
a controller outputting a plurality of current control signals when the temperature of the LED module and the temperature of the chamber are equal to each other;
a current supply unit applying a plurality of current pulses having a plurality of current values to the LED module responding to the current control signals;
and a voltage detection unit detecting a voltage of the LED module whenever the LED module is driven by each of the current pulses,
wherein the controller tabulates the temperatures of the LED module, the current values, and a plurality of pieces of information on the detected voltages by using a lookup table to store the tabulated results.

2. The apparatus of claim 1, wherein the temperatures are gradually raised by a predetermined level.

3. The apparatus of claim 1, wherein the current values of the current pulses are gradually raised by a predetermined level, and the current pulses are sequentially outputted from the current pulse having a low current value.

4. The apparatus of claim 3, wherein the current pulses are applied to the LED module at a distance of predetermined time.

5. The apparatus of claim 3, wherein each of the current pulses has a pulse width of about 910 μs.

6. The apparatus of claim 1, wherein the controller stores the temperature of the LED module when the temperature of the LED module and the temperature of the chamber are equal to each other.

7. The apparatus of claim 1, wherein the plurality of pieces of information on the current values are preset and are stored in the controller, and the controller generates current control signals corresponding to the plurality of pieces of information on the current values when the temperature of the LED module and the temperature of the chamber are equal to each other.

8. The apparatus of claim 1, wherein the chamber is set to have various temperatures by control of the controller.

9. The apparatus of claim 1, wherein the current supply unit is a constant current supply unit.

10. The apparatus of claim 1, wherein the detected voltage is a forward voltage of an LED of the LED module.

11. The apparatus of claim 1, wherein the controller comprises a memory tabulating the temperatures of the LED module, the current values, and a plurality of pieces of information on the detected voltages by using a lookup table to store the tabulated results.

12. A method for measuring a temperature of an LED, the method comprising:
setting, to predetermined temperature, a chamber in which an LED module is disposed therein;
measuring a temperature of the LED module and a temperature of the chamber;
generating a plurality of current pulses having a plurality of current values to apply the generated current pulses to the LED module when the temperature of the LED module and the temperature of the chamber are equal to each other;
detecting a voltage of the LED module whenever the LED module is driven by each of the current pulses;
tabulating the temperature of the LED module, the current values, and a plurality of pieces of information on the detected voltages by using a lookup table to store the tabulated results;
raising a temperature value set to the temperature of the chamber by a predetermined level;
comparing the temperature value and a maximum temperature; and
setting the temperature of the chamber to the temperature value when the temperature value is equal to or lower than the maximum temperature.

13. The method of claim 12, wherein the current values of the current pulses are gradually raised, and the current pulses are sequentially outputted from the current pulse having a low current value.

14. The method of claim 13, wherein the current pulses are applied to the LED module at a distance of predetermined time.

15. The apparatus of claim of claim 13, wherein each of the current pulses has a pulse width of about 910 μs.

16. The method of claim 12, further comprising storing the temperature of the LED module when the temperatures the LED module and the chamber are equal to each other.

17. The method of claim 12, wherein the generating of the current pulses comprises:
presetting and storing the plurality of pieces of information on the current values;
generating current control signals corresponding to the plurality of pieces of information on the current values when the temperatures the LED module and the chamber are equal to each other; and
responding to the current control signals to generate the current pulses, and applying the generated current pulses to the LED module.

18. The method of claim 12, wherein the current pulses are generated from a constant current supply unit.

19. The method of claim 12, wherein the detected voltage is a forward voltage of an LED of the LED module.
